(19) United States
(12) Patent Application Publication
(10) Pub. No.: US 2017/0326687 A1
(43) Pub. Date: Nov. 16, 2017

(54) DOUBLE-SIDED MACHINING LASER MACHINE TOOL

(71) Applicant: Chun-Hao LI, Taipei City (TW)

(72) Inventor: Chun-Hao LI, Taipei City (TW)

(21) Appl. No.: 15/208,251

(22) Filed: Jul. 12, 2016

(30) Foreign Application Priority Data
May 12, 2016 (CN) 201620426817.X

(51) Int. Cl. B23K 26/362; B23K 26/00; B23K 26/08; B23K 26/06; B23K 26/70; B23K 26/03; B23K 101/34; B23K 103/16

(52) U.S. Cl. CPC B23K 26/362; B23K 26/032; B23K 26/0006; B23K 26/0861; B23K 26/0648; B23K 26/0626; B23K 26/702; B23K 26/03; B23K 2203/172; B23K 2201/34

(57) ABSTRACT

A double-sided machining laser machine tool is provided for machining a workpiece having opposite first and second machining surfaces. The machine tool includes a laser machining apparatus and a mechanical arm. The laser machining apparatus includes a laser source, a light guiding-and-focusing lens assembly, a three-axis moving stage, an optical inspection device, and a control device. The control device drives the three-axis moving stage moving the workpiece to a machining horizontal coordinate and a machining altitude according to a current horizontal coordinate and a current altitude of the work piece. The control device drives the laser source and the light guiding-and-focusing lens assembly focusing the laser light to the first machining surface. The mechanical arm is controlled by the control device. When the machining of the first machining surface is finished, the mechanical arm flips over the workpiece to allow the laser machining apparatus to machine the second machining surface.

### CROSS-REFERENCES TO RELATED APPLICATIONS

This non-provisional application claims priority under 35 U.S.C. §119(a) on Patent Application No. 201620426817.X filed in China, P.R.C. on 2016 May 2012, the entire contents of which are hereby incorporated by reference.

### BACKGROUND

### Technical Field

The instant disclosure relates to a laser machine tool, in particular, to a double-sided machining laser machine tool.

### Related Art

With the developments of touch control technologies, numerous electronic devices are now typically provided with touch screens. However, the sensing electrodes of a capacitive touch screen are made by chemical wet manufacturing procedures including several steps such as mask manufacturing, development and exposure, chemical etching, cleaning, repeated wire forming and repairing, etc. The chemical wet manufacturing procedures are not only complicated, it is also hard to maintain a defect-free product rate.

### SUMMARY

In view of these problems, in one embodiment, a double-sided machining laser machine tool is provided. The double-sided machining laser machine tool is for machining a workpiece having a first machining surface and a second machining surface opposite to the first machining surface. The double-sided machining laser machine tool comprises a laser machining apparatus and a mechanical arm. The laser machining apparatus comprises a laser source, a light guiding-and-focusing lens assembly, a three-axis moving stage, an optical inspection device, and a control device. The laser source outputs a laser light. The light guiding-and-focusing lens assembly modulates the laser light and adjusts a traveling path of the laser light. The three-axis moving stage loads the workpiece and moves the workpiece along three axes. The optical inspection device detects a current horizontal coordinate of the workpiece and a current altitude of the workpiece. The control device drives the three-axis moving stage to move the workpiece to a machining horizontal coordinate and a machining altitude according to the current horizontal coordinate and the current altitude of the work piece. The control device drives the laser source and the light guiding-and-focusing lens assembly to focus the laser light to the first machining surface of the workpiece. The mechanical arm is connected to the laser machining apparatus so as to be controlled by the control device.

Accordingly, the double-sided machining laser machine tool of embodiments of the instant disclosure can be applied to a workpiece needed to be double-sided machined. By precise positioning and energy controlling, when the laser machine tool applies laser machining to one of the machining surfaces, the other machining surface is not harmed. Therefore, when the laser machine tool is applied to the touch panel procedure, the laser machine tool can replace the complicated wet manufacturing procedure, and the defect-free product rate can be improved.

### BRIEF DESCRIPTION OF THE DRAWINGS

The disclosure will become more fully understood from the detailed description given herein below for illustration only, and thus not limitative of the disclosure, wherein:

FIG. 1 illustrates a floor plan view for a double-sided machining laser machine tool according to an exemplary embodiment of the instant disclosure;

FIG. 2 illustrates a perspective view of a laser machining apparatus of the double-sided machining laser machine tool of an exemplary embodiment of the instant disclosure; and

FIG. 3 illustrates a block diagram view of the double-sided machining laser machine tool of an exemplary embodiment of the instant disclosure.

### DETAILED DESCRIPTION

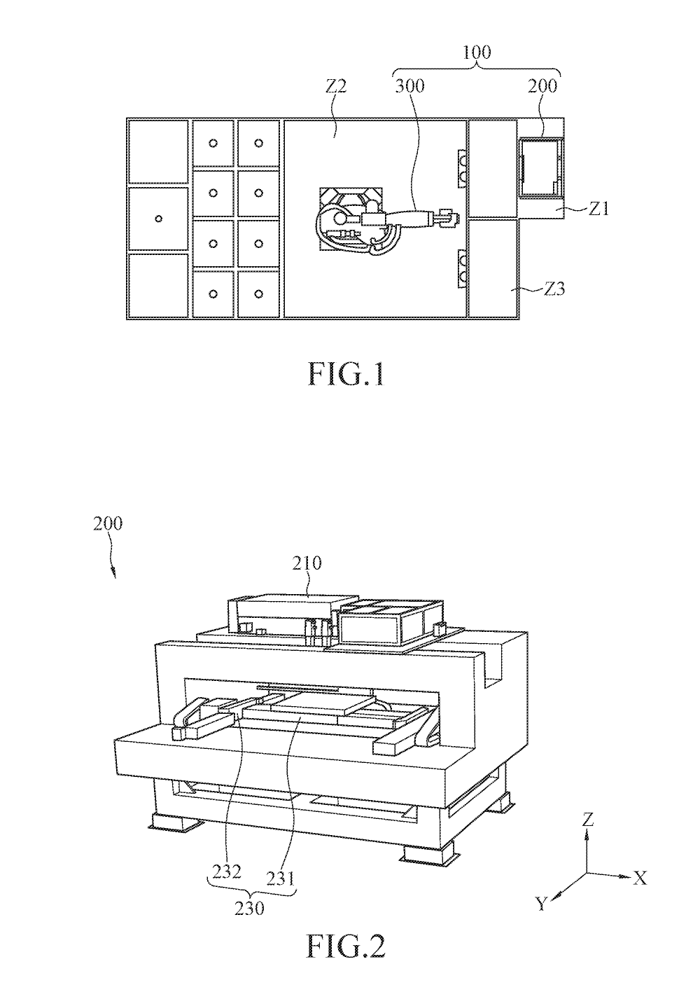

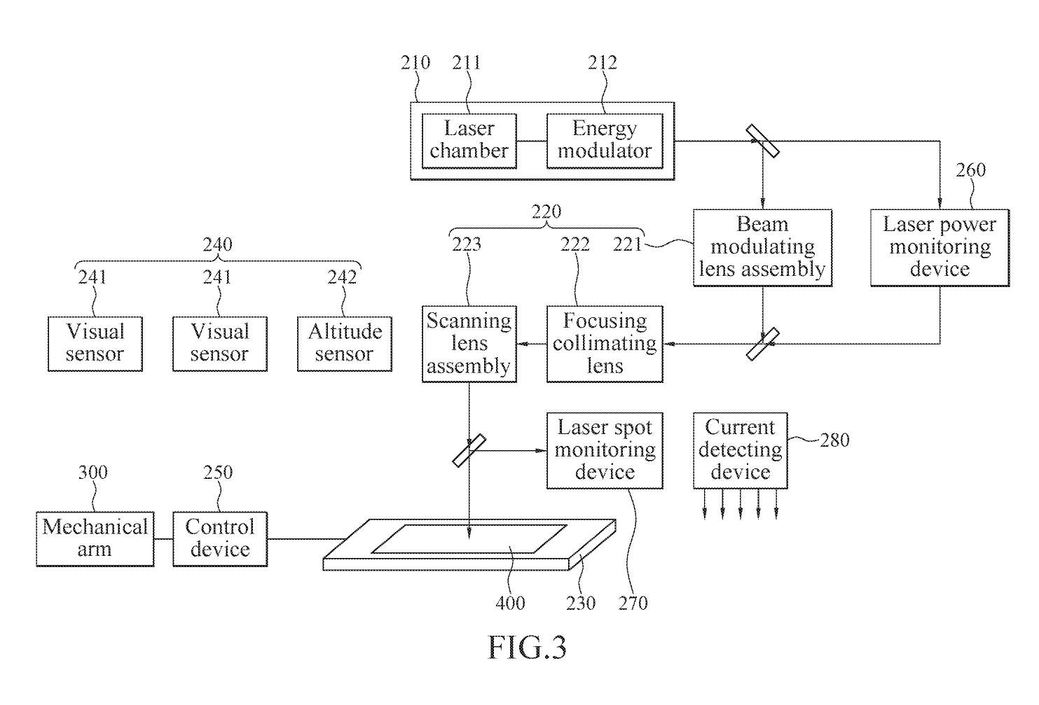

Please refer to FIG. 1, illustrating a floor plan view for a double-sided machining laser machine tool 100 (hereinafter, called laser machine tool 100), according to an exemplary embodiment of the instant disclosure. The laser machine tool 100 comprises a laser machining apparatus 200 and a mechanical arm 300. The laser machining apparatus 200 is disposed at a first zone Z1, the mechanical arm 300 is disposed at a second zone Z2, and the first zone Z1 is next to the second zone Z2. A third zone Z3 is respectively next to the first zone Z1 and next to the second zone Z2. The third zone Z3 is a loading and unloading zone for placing a workpiece 400 (as shown in FIG. 3). Further descriptions are provided later.

Please refer to FIGS. 2 and 3, respectively illustrating a perspective view of the laser machining apparatus 200 of the laser machine tool 100 and a block diagram view of the laser machine tool 100 of an exemplary embodiment of the instant disclosure. The laser machining apparatus 200 comprises a laser source 210, a light guiding-and-focusing lens assembly 220, a three-axis moving stage 230, an optical inspection device 240, and a control device 250.

The laser source 210 is for emitting a laser light. The workpiece 400 can be machined by the laser light. The workpiece 400 may be, for example, a double-sided ITO (indium tin oxide), conductive glass of a touch panel. The workpiece 400 has two opposite machining surfaces (i.e., a first machining surface and a second machining surface). When one of the machining surfaces is machined, the other machining surface is not damaged. Here, the thickness of a double-sided ITO conductive glass adapted for machining can be down to 0.4 mm; if a focusing system having specific light path alignments, the laser light may be applied to machine double-sided ITO conductive glasses having thinner thicknesses. The laser source 210 comprises a laser chamber 211 and an energy modulator 212. The laser chamber 211 is for generating the laser light. The energy modulator 212 is for adjusting the energy of the laser light and outputs an energy-adjusted laser light to the light guiding-and-focusing lens assembly 220. The laser light may be an ultraviolet laser light, but embodiments are not limited thereto; the laser source may be chosen based on the material of the workpiece 400. The energy modulator 212 may be, for example, a power modulator for adjusting the power of the laser light.

The light guiding-and-focusing lens assembly 220 is for modulating the laser light and adjusting a traveling path of the laser light. The light guiding-and-focusing lens assembly 220 comprises a beam modulating lens assembly 221, a focusing collimating lens 222, and a scanning lens assembly 223. The beam modulating lens assembly 221 is for modulating the beam profile of the laser light. Specifically in one embodiment, the beam modulating lens assembly 221 modulates the beam profile of the laser light as a flat wave, so that the output energy of the laser light can be uniform. The focusing collimating lens 222 is for adjusting the focusing spot and the focusing depth of the laser light. The scanning lens assembly 223 is for guiding and outputting the modulated laser light modulated by the energy modulator 212, the beam modulating lens assembly 221, and the focusing collimating lens 222 to a position corresponding to the workpiece 400, so that the location of the laser light focusing on the workpiece 400 can be changed, and the laser light can be applied to machine the workpiece 400.

The three-axis moving stage 230 is for loading the workpiece 400 and moving the workpiece 400 along three axes (i.e., the X-axis, the Y-axis, and the Z-axis). As shown in FIG. 2, the three-axis moving stage 230 comprises an XY-axis moving stage 231 and a Z-axis linear rail 232 connected to the XY-axis moving stage 231. The XY-axis moving stage 231 corresponds to the movements along the X-axis and the Y-axis. The Z-axis linear rail 232 corresponds to the movement along the Z-axis. The Z-axis linear rail 232 may be a ballscrew.

The optical inspection device 240 is for detecting a current horizontal coordinate (i.e., the XY-axis coordinate), and a current altitude of the workpiece 400. The optical inspection device 240 comprises one or two visual sensor 241 (in this embodiment, two visual sensors 241), and an altitude sensor 242. The visual sensors 241 and the altitude sensor 242 are above the workpiece 400. The visual sensor 241 is for downward capturing an image of the workpiece 400 to obtain the current horizontal coordinate of the workpiece 400. The altitude sensor 242 is for detecting a distance between the workpiece 400 and the altitude sensor 242 to obtain the current altitude of the workpiece 400. In this embodiment, the altitude sensor 242 detects the distance by a red semiconductor laser, but embodiments are not limited thereto. The distance may be detected by, e.g., infrared rays, ultrasonic waves, laser interferometers, etc., if the precision requirements can be satisfied. The visual sensor 241 may be a high-resolution camera having 500 million pixels. The control device 250 can analyze the images by image recognition techniques to confirm the horizontal coordinate of the workpiece 400.

The control device 250 drives the three-axis moving stage 230 to a machining horizontal coordinate and a machining altitude according to the current horizontal coordinate and the current altitude of the workpiece 400, and the control device 250 drives the laser source 210 and the light guiding-and-focusing lens assembly 220 to focus the laser light on the first machining surface of the workpiece 400. Accordingly, the laser light can be applied to go through the first machining surface of the workpiece 400 to form desired patterns on the first machining surface of the workpiece 400 (e.g., projective capacitive electrode patterns). The control device 250 may be a desktop computer, an industrial personal computer (IPC), an embedded controller, or other computation devices having calculating and controlling abilities. The control device 250 stores a control program can be capable of executing the control program.

The mechanical arm 300 is connected to the control device 250 of the laser machining apparatus 200 for being controlled by the control device 250. When the machining of the first machining surface of the workpiece 400 is finished, the mechanical arm 300 flips over the workpiece 400 to allow the laser machining apparatus 200 to machine the second machining surface of the workpiece 400, so that the laser light can be applied to go through the second machining surface of the workpiece 400 to form desired patterns on the second machining surface of the workpiece 400 (e.g., projective capacitive electrode patterns).

As shown in FIG. 3, the laser machining apparatus 200 may further comprise a laser power monitoring device 260, a laser spot monitoring device 270, and a current detecting device 280. The laser power monitoring device 260 is disposed at the bypass of the traveling path of the laser light for detecting the power of the laser light. The laser spot monitoring device 270 is also disposed at the bypass of the traveling path of the laser light for detecting the spot quality of the laser light. The current detecting device 280 is for detecting if conductive articles (in this embodiment, the ITO conductive film), that on the first machining surface and the second machining surface of the workpiece 400 and are to be machined on the workpiece 400, are burned by the laser light.

Please refer to FIG. 1 again. Before the machining, the workpiece 400 is placed at the unloading and loading zone (i.e., the third zone Z3). Next, the mechanical arm 300 moves the workpiece 400 to the three-axis moving stage 230 of the laser machining apparatus 200, so that the laser machining apparatus 200 applies laser machining to the first machining surface of the workpiece 400. When the machining of the first machining surface is finished, the mechanical arm 300 moves the workpiece 400 to the unloading and loading zone and flips over the workpiece 400 on the unloading and loading zone. Next, the flipped workpiece 400 is placed back to the three-axis moving stage 230, so that the laser machining apparatus 200 applies laser machining to the second machining surface of the workpiece 400. Consequently, the workpiece 400 having a huge volume can be flipped over and would not be impact to the laser machining apparatus 200 during the flipping.

Accordingly, the double-sided machining laser machine tool 100 of embodiments of the instant disclosure can be applied to a workpiece 400 needed to be double-sided machined. By precise positioning and energy controlling, when the laser machine tool 100 applies laser machining to one of the machining surfaces, the other machining surface would not be harmed. Therefore, when the laser machine tool 100 is applied to the touch panel procedure, the laser machine tool 100 can replace the complicated wet manufacturing procedure, and the defect-free rate of the products can be improved.

While the instant disclosure has been described by the way of example and in terms of the preferred embodiments, it is to be understood that the invention need not be limited to the disclosed embodiments. On the contrary, it is intended to cover various modifications and similar arrangements included within the spirit and scope of the appended claims, the scope of which should be accorded the broadest interpretation so as to encompass all such modifications and similar structures.

What is claimed is:

1. A double-sided machining laser machine tool, for machining a workpiece, the workpiece having a first machining surface and a second machining surface opposite to the first machining surface, wherein the double-sided machining laser machine tool comprises:
a laser machining apparatus, comprising:
a laser source emitting a laser light;
a light guiding-and-focusing lens assembly modulating the laser light and adjusting a traveling path of the laser light;
a three-axis moving stage loading the workpiece and moving the workpiece along three axes;
an optical inspection device detecting a current horizontal coordinate of the workpiece and a current altitude of the workpiece; and
a control device driving the three-axis moving stage to move the workpiece to a machining horizontal coordinate and a machining altitude according to the current horizontal coordinate and the current altitude of the workpiece, and the control device driving the laser source and the light guiding-and-focusing lens assembly to focus the laser light to the first machining surface of the workpiece; and
a mechanical arm connected to laser machining apparatus so as to be controlled by the control device, wherein when the machining of the first machining surface of the workpiece is finished, the mechanical arm flips over the workpiece to allow the laser machining apparatus to machine the second machining surface of the workpiece.

2. The double-sided machining laser machine tool according to claim 1, wherein the light guiding-and-focusing lens assembly comprises:
a beam modulating lens assembly modulating the beam profile of the laser light;
a focusing collimating lens adjusting a focusing spot of the laser light; and
a scanning lens assembly adjusting a location by where the laser light is focused on the workpiece.

3. The double-sided machining laser machine tool according to claim 1, wherein the three-axis moving stage comprises an XY-axis moving stage and a Z-axis linear rail connected to the XY-axis moving stage.

4. The double-sided machining laser machine tool according to claim 1, wherein the optical inspection device comprises:
one or two visual sensor above the workpiece for downward capturing an image of the workpiece to obtain the current horizontal coordinate; and
an altitude sensor detecting a distance between the workpiece and the altitude sensor to obtain the current altitude.

5. The double-sided machining laser machine tool according to claim 1, wherein the laser source comprises a laser chamber and an energy modulator, the laser chamber generates the laser light, the energy modulator adjusts the energy of the laser light and output an energy-adjusted laser light to the light guiding-and-focusing lens assembly.

6. The double-sided machining laser machine tool according to claim 1, wherein the laser machining apparatus further comprises:
a laser spot monitoring device detecting the spot quality of the laser light; and
a laser power monitoring device detecting the power of the laser light.

7. The double-sided machining laser machine tool according to claim 6, wherein the laser machining apparatus further comprises a current detecting device for detecting if conductive articles that on the first machining surface and the second machining surface of the workpiece and are to be machined on the workpiece, are burned by the laser light.

8. The double-sided machining laser machine tool according to claim 7, further comprising a loading and unloading zone for placing the workpiece, wherein the mechanical arm moves the workpiece with the machining of the first machining surface thereof being finished to the loading and unloading zone, and the mechanical arm flips the workpiece and places the flipped workpiece back to the three-axis moving stage.

9. The double-sided machining laser machine tool according to claim 1, wherein the laser machining apparatus further comprises a current detecting device for detecting if conductive articles that are on the first machining surface and the second machining surface of the workpiece and are to be machined on the workpiece, are burned by the laser light.

10. The double-sided machining laser machine tool according to claim 1, further comprising a loading and unloading zone for placing the workpiece, wherein the mechanical arm moves the workpiece with the machining of the first machining surface thereof being finished to the loading and unloading zone, and the mechanical arm flips the workpiece and places the flipped workpiece back to the three-axis moving stage.
